(19) United States
(12) Patent Application Publication
(10) Pub. No.: US 2026/0138814 A1
(43) Pub. Date: May 21, 2026

(54) COMPOSTABLE POD SHAPED FROM A SHEET OF CELLULOSE-BASED MATERIAL

(71) Applicant: SOCIÉTÉ DES PRODUITS NESTLÉ S.A., Vevey (CH)

(72) Inventors: Nicola GALAFFU, Ornex (FR); Karim MISSOUM, Pusignan (FR); Gerhard NIEDERREITER, Vevey (CH); Franco MAGNANI, Fidenza (Parma) (IT); Massimiliano MAINI, Fidenza (Parma) (IT)

(21) Appl. No.: 19/116,561

(22) PCT Filed: Sep. 28, 2023
(86) PCT No.: PCT/EP2023/076838

§ 371 Date: Mar. 28, 2025

(30) Foreign Application Priority Data
Sep. 30, 2022 (EP) 22199214.2

(51) Int. Cl. B65D 85/804; B65D 65/46

(52) U.S. Cl. CPC B65D 85/8046; B65D 65/466; B65D 2565/382

(57) ABSTRACT

The invention relates to a pod (100) for preparing a beverage in a beverage production machine. The pod (100) is made of a home-compostable material composition and comprises a pod body (120) being composed of two half-shells (200). The half-shells (200) are joined to each other so as to delimit a chamber (211) for containing a substance (500) for the preparation of the beverage. Each of the half-shells (200) is shaped from a sheet of biodegradable cellulose-based material having a barrier function. Each of the half-shells (200) comprises a bottom (250), a circumferential sidewall (240) and a circumferential rim (230), where the rim (230) of the respective other half-shell (200) is joined. The rim (230) and the sidewall (240) are directly connected by a circumferential rim transition area (234), which has a rim radius (R34) between 1 mm and 3 mm. Further, the sidewall (240) and the bottom (250) are directly connected by a circumferential bottom transition area (254), which has a bottom radius (R452) of 10 mm and 20 mm.

### 1. FIELD OF THE INVENTION

The present invention relates to a pod for preparing a beverage in a beverage production machine, which is made of a home-compostable material composition and composed of at least one half-shell shaped from a sheet of biodegradable cellulose-based material.

### 2. TECHNICAL BACKGROUND

Single-serve beverage containers for beverage preparation machines, such as capsules or pods, are known in the art. These beverage containers are commonly used for on demand dispensing of beverages, like coffee, tea or hot chocolate, and enjoy popularity due to fresh tasting, variability of flavours and convenience of the beverage preparation.

Usually, the beverage container encloses a beverage component and is inserted in a container receiver (e.g. a capsule holder) of a beverage preparation machine. The container receiver is closed, and the beverage preparation is started. A fluid, such as hot water or milk, is injected in the beverage container to interact with the beverage component inside the beverage container to produce the desired beverage. When a sufficient amount of the fluid fills the beverage container, the beverage container opens under the pressure of the fluid built up in the beverage container to release the prepared beverage. Such beverage preparation is convenient as users can simply decide for a beverage of their liking, place a beverage container of the desired flavour in a machine, start the beverage preparation process and consume the beverage shortly afterwards.

Typically, these known beverage containers are made of materials, for which reusing, recycling or composting is challenging, particularly after use of the beverage container. Therefore, efforts are made to replace these established materials with biodegradable or compostable materials, such as cellulose-based materials, like paper, for which the process of disposing used beverage containers is less challenging (e.g. via composting).

The use of new materials for beverage containers requires also new manufacturing processes. For instance, in industrial production, a beverage container made from cellulose-based material may be produced from an endless (continuous) sheet of a paper material that travels through different stations of a production line. At one station, a section of the sheet is formed into a half-shell and subsequently filled with a beverage component, such as coffee, before being sealed closed with another half-shell or lid.

Therein, it was found that moistening the sheet before forming the half-shell can be beneficial for the structural integrity and shelf-life of the resulting beverage container because the half-shells may break, tear or split due to mechanical stress during the forming process. These negative side-effects can be reduced by moistening the sheet before undertaking the forming step. An example for a manufacturing process implementing such moistening process can be found in WO 2020/031096 A1.

However, despite moistening the sheet material before forming, the creation of structural breaches, such as slits or cracks in the beverage container, during forming the beverage container cannot be completely eliminated. The breaches can be of a size making them visible or invisible, for instance in case of micro-cracks. Therein, micro-cracks can become particularly problematic for the beverage preparation process. As described above, the beverage preparation process typically relies on a sufficient pressure build up inside the beverage container to open the beverage container at the correct time. However, breaches in the container wall compromise beverage preparation as the pressure build up may become insufficient or too low, or the container wall may open at the wrong part of the beverage container. This may lead to a low-quality brewing product and user experience. Visible cracks have a similar negative impact on the beverage containers as they are not only problematic for aesthetics of the beverage container but also form passages into the container interior and thus, compromise the integrity and shelf-life of the food product inside the beverage container. Consequently, present manufacturing processes are insufficient to ensure the integrity, functionality, quality and shelf-life of the beverage container as well as the quality of the produced beverage and thus, solutions to overcome these issues are required.

In the prior art, attempts are made to address the above-described problems by replacing the paper sheet material with different materials or material combinations that provide the beverage container with higher mechanical flexibility, or that avoid forming the beverage container in a sheet forming process. However, such approaches lead to an increase in material and manufacturing costs. In addition, it is difficult to provide a beverage container that still facilitates home-composting.

Thus, it is an object of the invention to provide a pod made from a compostable material, in which the structural integrity and shelf-life of the produced pod can be improved and ensured. Therein, it is a further object of the invention to avoid the creation of breaches in the container wall during the sheet forming process without abandoning the ability of the pod for home-composting after its use.

These and other objects, which become apparent upon reading the description, are solved by the subject-matter of the independent claims. The dependent claims refer to preferred embodiments of the invention.

### 3. SUMMARY OF THE INVENTION

A first aspect of the invention relates to a pod for preparing a beverage in a beverage production machine.

Therein, the term “pod” may be understood, for example, as a receptacle for a substance for preparing a beverage in a beverage production machine, such as a capsule or any (closed) container. A beverage may be coffee or tea, for instance.

The pod is made of a home-compostable material composition.

For instance, the home-compostable material composition may comprise one or more constituents, each of the constituents or their combination may be a home-compostable substance.

Therein, the term “compostable” may be understood as meaning that a material may be substantially broken down into organic matter within a few weeks or months when it is composted. This may be accomplished in industrial composting sites and/or home composters. Specific conditions relating to wind, sunlight, drainage and other factors may exist at such sites. At the end of a composting process, the earth may be supplied with nutrients once the material has completely broken down. International standards, such as EU 13432 or US ASTM D6400, provide a framework for specifying technical requirements and procedures for determining compostability of a material.

In comparison, a “biodegradable” material may be understood as any material that can be broken down into environmentally innocuous products by (the action of) living things (such as microorganisms, e.g. bacteria, fungi or algae). This process can take place in an environment with or without the presence of oxygen (aerobic/anaerobic).

The pod comprises a pod body. The pod body is composed of two half-shells. The two half-shells are joined (connected, sealed) to each other so as to delimit a chamber (a closed space or volume) for containing a substance for the preparation of the beverage.

Each of the half-shells is shaped from a sheet of biodegradable cellulose-based material having a barrier function.

Therein, the term “shaping” may be understood, for example, as using the characteristic of a material being formable, malleable, and/or pliable to change its (three-dimensional) shape (with or without the support of additional tools, and/or preferably with or without the application of heat). The term “sheet” may be understood, for example, as a large, thin, flat, piece of material. The expression “barrier function” may be understood as providing a configuration inherent to or provided with the material that may prevent or block gases, such as oxygen, and/or fluids (i.e. liquid and/or vaporous substances) from entering and/or leaving the inside of the beverage container, preferably to an extent suitable for food applications. For instance, the cellulose-based material may be configured to provide a barrier function against gases, such as oxygen, flavouring substances or Carbon dioxide. For instance, the sheet may have an oxygen barrier with an oxygen transmission rate (OTR) below 5 cm³/m²/day. Therein, the OTR may be a measure of the amount of oxygen gas that passes through a substance over a defined period. OTR may be measured using known methods specified in industrial standards, such as DIN 53380-3, ASTM D1434 or ISO 2872. Additionally or alternatively, a moisture barrier may be provided.

Each of the half-shells comprises a bottom (e.g. lowest part of pod) and a circumferential sidewall. The (circumferential) sidewall extends from the bottom to a circumferential edge of the sidewall to define a cavity. The sidewall tapers (e.g. may radially and/or laterally decrease) from the circumferential edge (i.e. wider starting point) towards the bottom (i.e. narrower end point). Each of the half-shells comprises further a circumferential rim, which extends laterally outwards from the circumferential edge for being joined with the rim of the respective other half-shell so that their cavities together define the chamber. A circumferential inner edge of the rim delimits (e.g. may define the limits of) an opening of the cavity. The opening may be an aperture or passage from outside the pod to the cavity.

The rim and the sidewall are directly connected by a circumferential rim transition area (e.g. a section or portion), which has a rim radius of between 1 mm and 3 mm. The sidewall and the bottom are directly connected by a circumferential bottom transition area, which has a bottom radius of between 10 mm and 20 mm.

Therein, the expression “directly connected” may be understood, for example, as two structure being in immediate physical contact. Thus, for instance, no other structure may be found between two directly connected structures. The expression “radius” may be understood, for example, as a structure being provided with a rounding of an (interior or exterior) corner (edge), such as a fillet. Besides, the expression “radius” may be understood, for example, as definition of the length of such circular (segment) structure.

With the above configuration of the present invention, it is possible to reduce the risk of creating material breaches, such as slits, cracks or tearing, and thereby, improve the integrity, quality and shelf-life of the pod produced in the forming process of a cellulose-based sheet material. Accordingly, not only manufacturing efficiency but also the beverage preparation process can be improved as micro-cracks can be avoided.

Therein, the inventors have surprisingly found that the provision of transition areas, which comprise a rounding of the above specified dimensions, at the respective sections of a pod for beverage production machines significantly reduces the mechanical stresses on the sheet material during the forming process. With this, the stress concentration on the respective sections of the sheet material can be reduced by distributing the forming stresses over a wider area. Moreover, the transition areas provide the pod with a more spherical shape, which leads to a smaller surface area for the intended pod volume and thus, leads to a reduced material consumption. Accordingly, forming forces required for forming the sheet material into the required shape can be reduced. The configuration of the pod according to the invention has also benefits for the beverage preparation process. The more spherical shape of the pod allows occurring stresses from the pressure built up in the pod to be distributed evenly in the pod body, which is beneficial for the relatively low wall thicknesses of the pod, as the relatively high brewing pressures required for the beverage preparation process can be achieved so that the pod can be opened at the right time and the brewing product is only released through the works of the (pod internally or externally) provided opening mechanisms.

Thus, the present invention overcomes problems and disadvantages of the prior art.

According to a preferred embodiment, the rim radius may be between 1.5 mm and 2.5 mm. However, it is also conceivable that the rim radius may be around 2 mm. The rim radius may be preferably provided (formed) such that it may bulge inwardly with respect to the cavity. For instance, the rim radius may be concave or a concave geometry.

Alternatively or additionally, the bottom radius may be between 12 mm and 15 mm, preferably between 13 mm and 14 mm. Preferably, the bottom radius may bulge outwardly with respect to the cavity. For instance, the bottom radius may be concave or a concave geometry.

With any one of the above configurations, the beneficial effects described above can be amplified even further.

According to a further preferred embodiment, the rim transition area may extend over a top transition angle of between 90° to 160°, preferably between 110° to 140°, most preferably between 120° to 130° in a vertical cross-section. Alternatively or additionally, the bottom transition area may extend over a bottom transition angle of between 20° to 90°, preferably between 15° to 60°, most preferably between 20° to 40° in a vertical cross-section.

Therein, the expression “transition angle” may be understood, for example, as defining the angle, over which the respective transition area (or radius) extends (within a sectional plane). This may be, for instance, the angle as measured between start and end point of the transition area with respect to the (imaginary) centre point of its respective radius.

Thereby, the steepness and the length of the respective transition area can be defined, thereby adapting the stress profile existing during the forming process.

According to a preferred embodiment, a bottom-side section of the sidewall may be directly connected with a rim-side section of the sidewall by a circumferential sidewall transition area. The circumferential sidewall transition area may have a sidewall radius of between 2 mm and 4 mm, preferably around 3 mm, most preferably of 3 mm. Alternatively or additionally, the sidewall radius may bulge outwardly with respect to the cavity. For instance, the sidewall radius may be convex or a convex geometry. Preferably, the sidewall transition area may extend over a sidewall transition angle of between 20° to 80° preferably between 25° and 45° in a vertical cross-section, when measured in the direction of radius R451.

Thereby, an additional segment of the pod sidewall can be provided with a defined transition area, which further reduces the level of mechanical stress during the pod shaping process by redistributing the stress concentration more favourably.

According to a further preferred embodiment, the bottom may be flat. Alternatively or additionally, the bottom may extend in a bottom plane. Preferably, the bottom may have a bottom surface area of between 170 mm² and 500 mm². Alternatively or additionally, the bottom may have a diameter of between 15 mm to 25 mm, or preferably of 20 mm.

Thereby, a pod can be provided that is compatible with existing established beverage production machines. In addition, the above specifications are beneficial for using the bottom as an extraction face of the pod in the beverage preparation process. For this function, a relatively large and flat surface may be advantageous.

According to a preferred embodiment, the rim may have an outer diameter of between 35 mm to 50 mm, preferably between 40 mm to 45 mm, more preferred between 41 mm to 42 mm. Preferably, the cavity may have a height (measured along the shortest distance between the bottom and the opening) of between 5 mm to 7 mm, or preferably of 6 mm.

Thereby, a pod can be provided that is compatible with existing established beverage production machines and that can provide sufficient volume for receiving the substance needed for the beverage preparation.

According to a further preferred embodiment, the sidewall may extend from the rim towards the bottom with decreasing diameter. Preferably, the circumferential edge or the opening may extend in a top plane. More preferred, the bottom plane and the top plane may be parallel to each other.

Thereby, it is possible to improve the manufacturing process of the pod because the half-shell can be removed more easily from the forming station. In addition, the pod can be filled more compactly and conveniently before being sealed closed.

According to a further preferred embodiment, in a vertical cross-section, the sidewall may extend at least partially along a sidewall plane. Preferably, the sidewall may extend at least partially along a sidewall plane at the rim-side section of the sidewall. Therein, the sidewall plane and the top plane (or the bottom plane) may preferably enclose an angle of between 50° to 60°, preferably between 55° and 58°. Alternatively or additionally, the sidewall plane and the top plane may enclose an angle of between 50° to 60°, preferably between 55° and 58°.

Thereby, the shape of the pod can be optimized regarding the concentration of stress during the forming process because a defined transitional profile can be provided between the rim transition area and the bottom transition area, or between the rim transition area and the circumferential sidewall transition area, if present.

According to a preferred embodiment, the half-shells may be shaped from a sheet having a multi-layered structure. The multi-layered structure may comprise at least one primary layer made of a cellulose-based material or a regenerated cellulose material. Moreover, the multi-layered structure may comprise at least a secondary layer having the barrier function, preferably an oxygen barrier function.

Thereby, it is possible to tailor the material composition of the sheet to the requirements of the application. For instance, layers may be added to provide defined functionalities, such as an oxygen and/or moisture barrier.

According to a further preferred embodiment, in a top view, the pod, each of the half-shells and/or the respective openings may have a round shape or contour, preferably a circular or oval shape or contour.

Thereby, a pod can be provided that is compatible with existing established beverage production machines and that has a reduced manufacturing complexity.

A further aspect of the present invention relates to a pod for preparing a beverage in a beverage production machine, wherein the pod is made of a home-compostable material composition. The pod comprises a pod body being composed of a half-shell and a lid, such as a membrane, which are joined to each other so as to delimit a chamber for containing a substance for the preparation of the beverage. The half-shell is shaped from a sheet of biodegradable cellulose-based material having a barrier function. The half-shell comprises a bottom, a circumferential sidewall and a circumferential rim. The circumferential sidewall extends from the bottom to a circumferential edge of the sidewall to define a cavity. Furthermore, the sidewall tapers from the circumferential edge towards the bottom. The circumferential rim extends laterally outwards from the circumferential edge for being joined with the lid for closing the chamber. Therein, a circumferential inner edge of the rim delimits an opening of the cavity. A circumferential rim transition area, which directly connects the rim and the sidewall, has a rim radius of between 1 mm and 3 mm. A circumferential bottom transition area, which directly connects the sidewall and the bottom, has a bottom radius of between 10 mm and 20 mm.

Thereby, a pod with the same advantages and beneficial effects as described above for the pod according to the first aspect of the invention can be provided.

Naturally, the pod in the further aspect of the invention may comprise all of the features described above for the pod according to the first aspect of the invention. However, for reasons of brevity, an explicit reiteration of these features is omitted at this juncture.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIG. 1 shows a schematic cross-section of a part of a pod body of a pod according to an embodiment of the invention.

FIG. 2 shows a schematic cross-section through a wall portion of a pod according to an embodiment of the invention.

FIG. 3 shows a schematic cross-section of a pod according to an embodiment of the invention.

FIG. 4 shows a schematic cross-section of a pod according to a further embodiment of the invention.

### 5. DETAILED DESCRIPTION

As used in this specification, the words “comprises”, “comprising”, and similar words, are not to be interpreted in an exclusive or exhaustive sense. In other words, they are intended to mean including, but not limited to.

Any reference to prior art documents in this specification is not to be considered as an admission that such prior art is widely known or forms part of the common general knowledge in the field.

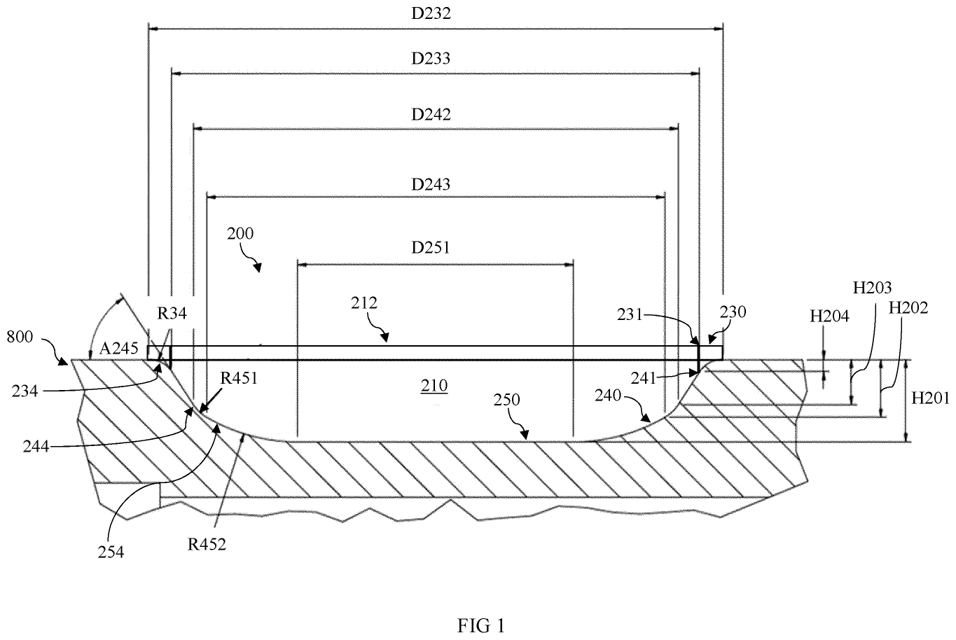

FIGS. 1 to 4 show different views and aspects of different embodiments of a pod 100 according to the present invention.

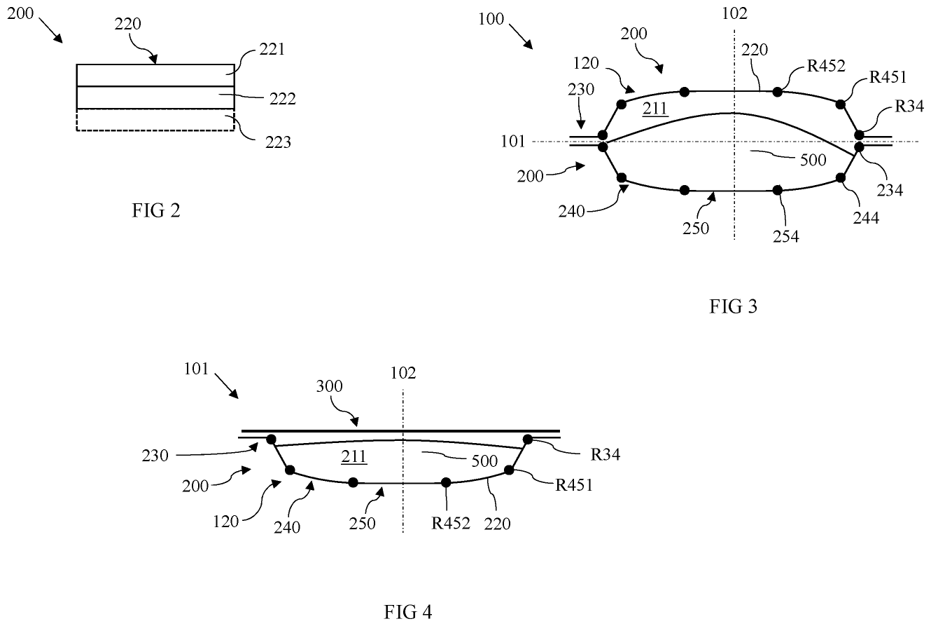

A first aspect of the invention relates to a pod 100 for preparing a beverage in a beverage production machine. For example, FIGS. 2 and 3 show two different embodiments of such beverage container.

The pod 100 may be configured to work with existing beverage production machines (e.g. capsule machines). The pod 100 may have a round shape or contour, preferably a circular or oval shape or contour, when seen in a top view. The pod 100 may be mirror symmetrical to horizontal plane 101 and/or vertical plane 102. This is exemplarily shown in FIGS. 1, 3 and 4. The pod 100 is made of a home-compostable material composition. For instance, the material composition may comprise a cellulose-based material, paper, parchment paper, paperboard, cellulose nanofibres, airlaid cellulose and/or delignified wood. Alternatively or additionally, the material composition may comprise compostable plastic materials, such as an extruded biopolymer, compostable coatings, and/or polylactic acid (PLA). Alternatively or additionally, the material composition may comprise compostable or biodegradable polyesters or polyvinylalcool polymers or combination thereof. However, this is not a complete enumeration of suitable home-compostable material compositions for the pod 100.

The pod 100 comprises a pod body 120. The pod body 120 may define the limits and boundaries of the volume taken up by the pod 100. The pod body 120 is composed of two half-shells 200. This is exemplarily illustrated in FIG. 3.

FIGS. 1, 3 and 4 show different examples of the half-shells 200. Each of the half-shells 200 is shaped from a sheet material. Therein, the half-shells 200 may have any shape or form. For instance, in a top view, each of the half-shells 200 may have a round, circular, or oval shape or contour. FIG. 1 shows an example of the forming process of one of the half-shells 200 in a forming die 800. The forming die 800 may have a corresponding shape or contour to the outer shape and contour of the respective half-shell 200 (as described hereinbefore and in the following). For the shaping of the sheet, the forming die 800 may cooperate with a correspondingly designed plunger element that may have a corresponding outer shape or contour to the shape or contour of the half-shell 200 at the inside. The forming die 800 and/or the plunger may be heated. The half-shell 200 may be shaped within a single shaping step.

The half-shells 200 are shaped from a biodegradable cellulose-based sheet material having a barrier function. For instance, paper or a pulp material may be used. Preferably, a sheet having a multi-layered structure may be used for shaping the half-shells 200. FIG. 2 shows an example for a multi-layered configuration of a wall 220 of the half-shells 200. Therein, the multi-layered structure may comprise at least one primary layer 221 made of a cellulose-based material or a regenerated cellulose material. Additionally, the multi-layered structure may comprise a secondary layer 222 having said barrier function. For instance, the barrier function may be an oxygen barrier function or a moisture barrier function. However, it is also conceivable that the multi-layered structure may comprise one or more additional functional layers 223 to provide an oxygen and a moisture barrier function to prevent moisture or oxygen to enter the pod interior. Alternatively or additionally, it is also conceivable that the wall 220 may comprise only a layer made of a cellulose-based material or a regenerated cellulose material, preferably having a thickness to provide the required barrier function.

Each of the half-shells 200 comprises a bottom 250. FIGS. 1, 3 and 4 show the bottom 250 exemplarily. The bottom 250 may be flat and may extend in a bottom plane. However, other configurations of this portion (part) of the half-shell 200 (i.e. of the bottom 250) may be conceivable. Preferably, the bottom 250 may have a bottom surface area of between 170 mm² and 500 mm², preferably 315mm². The bottom 250 may have a diameter D251 between 15 mm to 25 mm. Preferably, the diameter D251 may be 20 mm.

Each of the half-shells 200 comprises a circumferential sidewall 240. FIGS. 1, 3 and 4 show the sidewall 240 exemplarily. The circumferential sidewall 240 extends (continuously) from the bottom 250 to a circumferential edge 241 of the sidewall 240. Therein, a cavity 210 is defined, which may be delimited by (at least) the circumferential edge 241, the circumferential sidewall 240 and the bottom 250. Preferably, the sidewall 240 may form a continuous mantle surface of the half-shell 200.

A circumferential bottom transition area 254 directly connects the sidewall 240 and the bottom 250. FIGS. 1, 3 and 4 illustrate the bottom transition area 254 exemplarily. From these Figures, it can be seen that the bottom transition area 254 may provide a link between the sidewall 240 and the bottom 250. Therein, the bottom transition area 254 may comprise a defined transitional geometry, such as a rounding, like a radius or fillet, having a defined size. More specifically, bottom transition area 254 has a bottom radius R452 of between 10 mm and 20 mm. Preferably, the bottom radius R452 may be between 12 mm and 15 mm, preferably between 13 mm and 14 mm. The geometrical extent of the bottom radius R452 may further be defined by a bottom transition angle, which, for example, may determine the size of the radius (element). For instance, in a vertical cross-section (e.g. in FIG. 1), the bottom transition area 254 may extend over the bottom transition angle being between 20° to 90°, preferably between 15° to 60°, most preferably between 20° to 40° when measured in direction of bottom radius R452. Thereby, the bottom radius R452 may bulge outwardly with respect to the cavity 210 as shown in FIG. 1.

Each of the half-shells 200 comprises a circumferential rim 230. FIGS. 1, 3 and 4 exemplarily show the rim 230. The rim 230 extends laterally outwards from the circumferential edge 241 for being joined with the rim 230 of the respective other half-shell 200 so that their cavities 210 together define a chamber 211. A circumferential inner edge 231 of the rim 230 delimits an opening 212 of the cavity 210. This is exemplarily illustrated in FIG. 1. Preferably, the rim 230 may extend completely around the sidewall 240. In a top view, the opening 212 may have a round, circular or oval shape or contour. The circumferential edge 241 and/or the opening 212 may extend in a top plane. FIG. 1 further illustrates that said bottom plane of the bottom 250 and the top plane may be parallel to each other. Preferably, the cavity 210 may have a height H201 of between 5 mm to 7 mm, preferably of 6 mm, when measured along the shortest distance between the bottom 250 and the opening 212. The rim 230 may have an outer diameter D232 of between 35 mm to 50 mm, preferably between 40 mm to 45 mm, more preferred between 41 mm to 42 mm. Moreover, the rim 230 may have an inner diameter D233, which may correspond with the diameter of the opening 212. For instance, the inner diameter 233 may be in the range of 30 mm to 40 mm. preferably may be 38 mm to 39 mm.

The rim 230 and the sidewall 240 are directly connected by a circumferential rim transition area 234. FIGS. 1, 3 and 4 illustrate this. The rim transition area 234 may comprise a defined transitional geometry, such as a rounding, like a radius or fillet, having a defined size. For example, the rim transition area 234 has a rim radius R34. The rim radius R34 is between 1 mm and 3 mm. Alternatively or additionally, the rim radius R34 may be between 1.5 mm and 2.5 mm, preferably 2 mm. In a vertical cross-section (e.g. as in FIG. 1), the rim transition area 234 may extend over a top transition angle of between 90° to 160°, preferably between 110° and 140°, most preferably between 120° and 130°. Preferably, the rim radius R34 may extend such that a height H204 in the range of 0.5 mm to 1.5 mm may be covered by the rim radius R34. The rim radius R34 may bulge inwardly with respect to the cavity 210. Additionally, the rim transition area 234 may have straight sections or portions that may extend between the rim radius R34 and the bottom transition area 254 with the bottom radius R452. This is exemplarily shown in FIG. 1. For instance, in a vertical cross-section, the sidewall 240 may extend at least partially along a sidewall plane, preferably at a rim-side section of the sidewall 240. The sidewall plane and the top plane, and/or the sidewall plane and the top plane may enclose an angle A 245 of between 50° to 60°, preferably between 55° and 58°. Thereby, it is conceivable that the sidewall 240 may extend from the rim 230 towards the bottom 250 with decreasing diameter, as exemplarily illustrated in FIG. 1.

It is further conceivable that the sidewall 240 comprises a circumferential sidewall transition area 244, which directly connects a bottom-side section of the sidewall 240 with a rim-side section of the sidewall 240. FIGS. 1, 3 and 4 show this exemplarily. The sidewall transition area 244 may comprise a defined transitional geometry, such as a rounding, like a radius or fillet, having a defined size. For example, the sidewall transition area 244 may have a sidewall radius R451 of between 2 mm and 4 mm, preferably around 3 mm, most preferably of 3 mm. Therein, the sidewall radius R451 may bulge outwardly with respect to the cavity 210. In a vertical cross-section, the sidewall transition area 244 may extend over a sidewall transition angle of between 20° to 80°, preferably between 25° and 45° in vertical cross-section, when measured in the direction of radius R451. For example, at the rim-side section of the sidewall 240 a diameter D242 in the range between 33 mm to 36 mm may be found, preferably the diameter D242 may be around 35 mm. At the bottom-side section of the sidewall 240 a diameter D243 in the range between 31 mm to 35 mm may be found, preferably the diameter D243 may be around 33 mm. The sidewall transition area 244 may have a height of around 1 mm to 2 mm, taking into consideration a preferential vertical height of 2 mm to 4 mm for height H203, and 3 mm to 5 mm for height H202.

The two half-shells 200 are joined to each other so as to delimit the chamber 211 for containing a substance 500 for the preparation of the beverage. For instance, the two half-shells 200 may be joined to each other by heat sealing or ultrasonic sealing. Preferably, the chamber may be sealed or closed from the outside after joining of the two half-shells 200. This is exemplarily illustrated in FIG. 3.

For example, when injecting a fluid (such as hot (40° C. to 100° C.) water or milk) inside the pod 100 for the beverage preparation, the substance 500 may interact with the fluid injected in the chamber 211 to produce the desired beverage. Thus, the chamber 211 may constitute a brewing chamber of the beverage preparation machine or in the beverage preparation process. Examples for substances may be roasted ground coffee, instant coffee, tealeaves, syrup concentrate, fruit extract concentrate, chocolate, dehydrated edible substances, and/or combinations thereof.

A further aspect of the present invention relates to a differently configured pod 101 for preparing a beverage in a beverage production machine. As the above-described pod 100, the differently configured pod 101 is made of a home-compostable material composition. However, unlike the above-described pod 100, the differently configured pod 101 comprises a pod body 120 being composed of only one of the above-described half-shells 200 and a lid 300, such as membrane. The lid 300 and the half-shell 200 are joined to each other so as to delimit a chamber, such as the chamber 211, for containing a substance, such as the substance 500, for the preparation of the beverage. FIG. 4 shows the pod 101. Therein, the half-shell 200 and the lid 300 may be joined to each other by heat sealing or ultrasonic sealing.

Although the invention has been described by way of example, the invention is not limited by the embodiments as described hereinabove, as long as being covered by the appended claims. It should be appreciated that variations and modifications may be made without departing from the scope of the invention as defined in the claims. All the features of the embodiments described hereinabove can be combined in any possible way and be provided interchangeably. Furthermore, where known equivalents exist to specific features, such equivalents are incorporated as if specifically referred in this specification.

1. A pod for preparation of a beverage in a beverage production machine, wherein the pod is made of a home-compostable material composition,
wherein the pod comprises a pod body composed of two half-shells joined to each other so as to delimit a chamber for containing a substance for the preparation of the beverage,
wherein each of the half-shells is shaped from a sheet of biodegradable cellulose-based material having a barrier function, and
wherein each of the half-shells comprises:
a bottom,
a circumferential sidewall extending from the bottom to a circumferential edge of the sidewall to define a cavity, wherein the sidewall tapers from the circumferential edge towards the bottom,
a circumferential rim extending laterally outwards from the circumferential edge for being joined with the rim of the respective other half-shell so that their cavities together define the chamber, wherein a circumferential inner edge of the rim delimits an opening of the cavity,
wherein a circumferential rim transition area which directly connects the rim and the sidewall, has a rim radius of between 1 mm and 3 mm, and
wherein a circumferential bottom transition area, which directly connects the sidewall and the bottom has a bottom radius between 10 mm and 20 mm.

2. The pod according to claim 1, wherein the rim radius is between 1.5 mm and 2.5 mm, and/or bulges inwardly with respect to the cavity.

3. The pod according to claim 1, wherein, in a vertical cross-section, the rim transition area extends over a top transition angle between 90° to 160°.

4. The pod according to claim 1, wherein the bottom radius is between 12 mm and 15 mm, and/or bulges outwardly with respect to the cavity.

5. The pod according to claim 1, wherein, in a vertical cross-section, the bottom transition area extends over a bottom transition angle between 10° to 90°.

6. The pod according to claim 1, wherein a circumferential sidewall transition area, which directly connects a bottom-side section of the sidewall with a rim-side section of the sidewall, has a sidewall radius of between 2 mm and 4 mm.

7. The pod according to claim 1, wherein, in a vertical cross-section, the sidewall transition area extends over a sidewall transition angle of between 20° to 80°.

8. The pod according to claim 1, wherein the bottom has a bottom surface area between 170 mm² and 500 mm², and/or the bottom has a diameter between 15 mm to 25 mm.

9. The pod according to claim 1, wherein the rim has an outer diameter between 35 mm to 50 mm.

10. The pod according to claim 1, wherein the cavity has a height measured along the shortest distance between the bottom and the opening between 5 mm to 7 mm. 6mm.

11. The pod according to claim 1, wherein the sidewall extends from the rim towards the bottom with decreasing diameter.

12. The pod according to claim 1, wherein the bottom is flat and/or extends in a bottom plane, and/or the circumferential edge or the opening extends in a top plane.

13. The pod according to claim 1, wherein, in a vertical cross-section, the sidewall extends at least partially along a sidewall plane.

14. The pod according to claim 1, wherein the half-shells are shaped from a sheet having a multi-layered structure, comprising:
at least one primary layer made of a cellulose-based material or a regenerated cellulose material, and
a secondary layer having the barrier function.

15. The pod according to claim 1, wherein, in a top view, the pod each of the half-shells and/or the respective openings have a round shape or contour.

16. The pod according to claim 1, wherein, in a vertical cross-section, the sidewall extends at least partially along a sidewall plane at a rim-side section of the sidewall.

17. The pod according to claim 16, wherein the sidewall plane and the top plane, and/or the sidewall plane and the bottom plane enclose an angle between 50° to 60°.

18. The pod according to claim 12, wherein the bottom plane and the top plane are parallel to each other.
